(19) United States
(12) Patent Application Publication
(10) Pub. No.: US 2008/0074396 A1
(43) Pub. Date: Mar. 27, 2008

(54) Device for numerology calculation

(76) Inventor: Jodi Maire Treuhaft, Apple Valley, CA (US)

Correspondence Address: EDWIN TARVER, 16830 Ventura Blvd., SUITE 360, Encino, CA, 91436, US

(21) Appl. No.: 11/527,660

(22) Filed: Sep. 22, 2006

(51) Int. Cl. G09G 5/00

(52) U.S. Cl. 345/169

(57) ABSTRACT

A numerology calculation device comprising an input unit, a display unit and a processing unit connected to the input unit. The input unit includes a plurality of input keys corresponding to numbers 1 to 9 and letters A to Z for entering content such as words, phrases, dates, including a combination of letters and numbers. The entered content is displayed on a screen on the display unit. Each of the letters is assigned a single digit number from 1 to 9. The device calculates the single digit numerical value of texts entered into the device, and the input unit further comprises functional keys for calculating the single digit numerical value of vowels and consonants entered into the device.

### CROSS-REFERENCE TO RELATED APPPLICATION

None

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates in general to calculating devices and more particularly to a device for calculating the numerological value of a name, phrase, number, or a combination thereof; the calculations based on Pythagorean numerology.

Calculating devices are well known in the art. In addition, calculating devices that employ specific complex calculations, such as square root and trigonometric functions have also been developed. In the fields of astrology and numerology, a limited number of calculating devices have been created to carry out even more specialized calculations.

For example, Intl. App. No. JP2002035405 to Yoshiko discloses a fortune-telling service system on the Internet. The service system, appearing as a web page on the Internet, includes a database which stores beforehand fortune-telling object information such as date of birth and its corresponding fortune information. Therefore, a user who wants to make use of the service system is prompted to enter the input data such as date of birth. Once entered, the service system retrieves the corresponding fortune information from the database and displays it on the web page. The present invention contemplates a physical device, rather than an application that operates over the Internet.

Intl. App. No. WO9952037 to Manfred discloses a device for reproducing an astrological prediction. The device comprises a housing enclosing an input unit, output unit, memory unit, and a control unit. The control unit connects the input unit and the output unit. The control unit is also connected to the memory unit, where sets of data relating to astrological predictions for a specific sign of the zodiac and a specific date are stored. This device differs from the present invention, in that it calculates values according to an astrological rather than numerological system.

Intl. App. No. FR2678404 to Alain discloses a device intended for carrying out astronomical calculations related to a date and also for providing the respective interpretation thereof. The device comprises a housing which in turn comprises electronic components including a microprocessor and a memory. One face of the device includes a key pad for the entry of data, and an electronic display device for displaying the results thereof. Although the above two inventions and the present invention are structurally similar, still the present is distinguishable as its calculations are based on numerology rather than astrology.

Therefore, it is an object of the present invention to provide a device for calculating the numerological value of a text or multiple texts based on numerology theory.

Another object is to provide a device for calculating the numerological value of a text or multiple texts, which is compact, portable, and easy to use. These and other objects of the present invention will become better understood with reference to the appended Summary, Description, and Claims.

### SUMMARY

Numerology involves assigning numbers to letters, and calculating a total derived from the assigned numbers of each letter in a word or a group of words. The present invention is a portable device for numerology calculation. The device comprises an input unit and a display unit attached to the input unit by a hinge connection. The input unit comprises a plurality of input keys corresponding to the numbers 1 to 9 and letters A to Z. The ‘A’ to ‘I’ keys are located below the keys ‘1’ to ‘9’, respectively; the ‘J’ to ‘R’ keys are below the keys ‘A’ to ‘I’, and the keys ‘S’ to ‘Z’ are below the keys ‘J’ to ‘Q’. A user can enter data into the device by using the input keys. The input unit further includes a functional key for calculating a final single digit number by combining the numbers assigned to each letter in the typed content. The typed content and the total are displayed on the screen of the display unit. Functional keys for calculating only vowel and only consonant numbers in the typed content are also provided.

### BRIEF DESCRIPTION OF THE FIGURES

FIG. 1 is an illustration of the device of the present invention in an opened condition.

FIG. 2 is an illustration of the top view of the device in a closed condition.

FIGS. 3 and 4 are side and front views of the device in a closed condition.

### FIGURES—REFERENCE NUMERALS

10 Device of the Present Invention
11 Input Unit
12 Display Unit
13 Screen
14 Hinge Connection
15 Content Input Key
16 Space Key
17 Delete Key
18 Clear Key
19 On/off Key
20 First Functional Key
21 Second Functional Key
22 Third Functional Key

### DETAILED DESCRIPTION

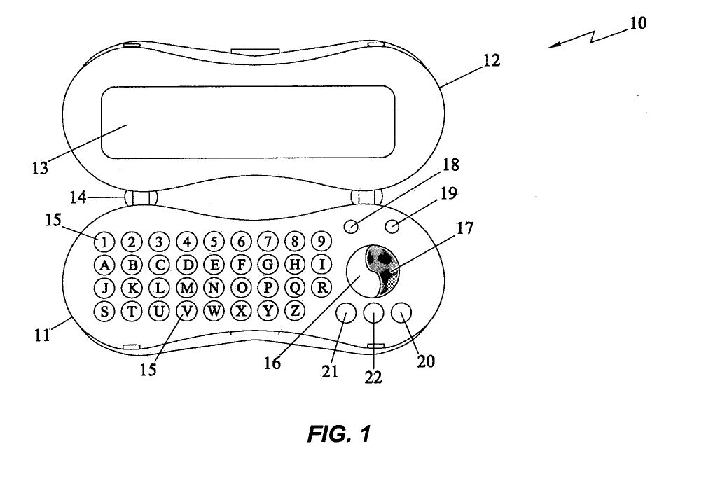

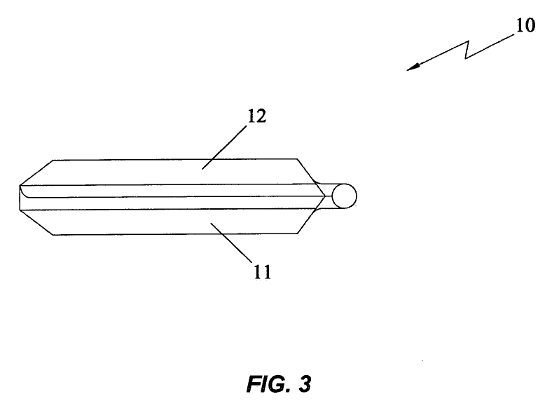

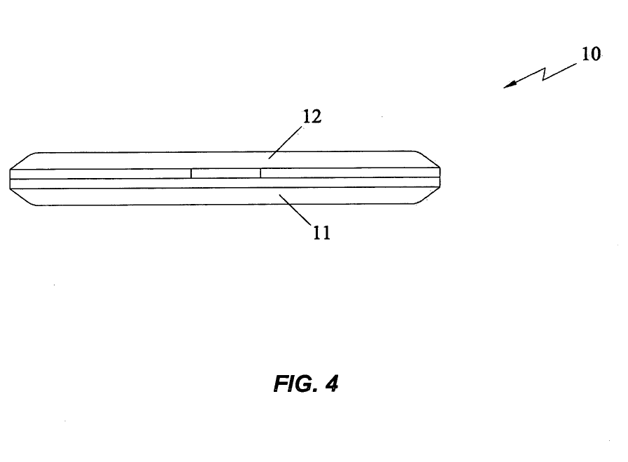

Referring to the drawings, a preferred embodiment of a device for numerology calculation is illustrated and generally indicated as 10 in FIGS. 1 through 4. The device 10 calculates numbers according to the Pythagorean numerological system. In this system, the letters A to I are assigned values 1 to 9, respectively; J to R are also assigned values 1 to 9; and S to Z are assigned numbers 1 to 8.

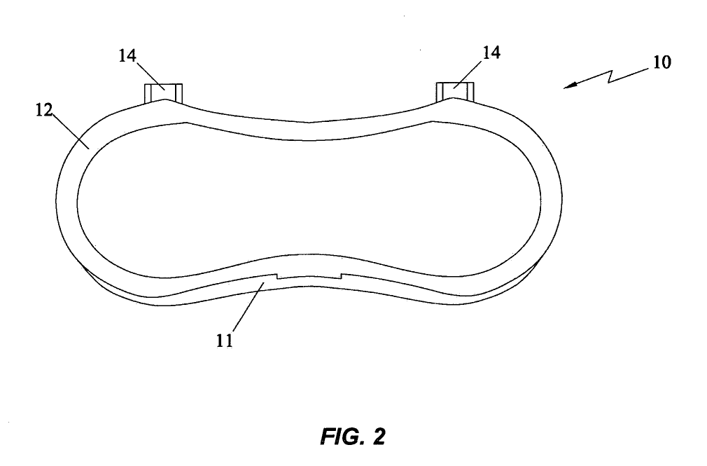

Referring to FIGS. 1 and 2, the device 10 comprises an input unit 11 and a display unit 12 having a screen 13. A processing unit (not shown) is housed in the input unit 11. The display is attached to the input unit by a hinge connection 14. The device can be opened and closed by rotating the display unit 12 about the hinge connection 14. The display unit 12 can be snapped closed by aligning the input unit 11 with the display unit 12. The hinge connection 14 enables the display unit to be positioned at any angle for clear view of the screen 13.

The input unit 11 comprises a plurality of input keys 15 corresponding to numbers 1 to 9 and letters A to Z for entering content such as letters, words, and numbers, including a combination of these. The input keys 15 are arranged to form a row and column arrangement. Specifically, the keys ‘A’ to ‘I’ are located below the keys ‘1’ to ‘9’, the keys ‘J’ to ‘R’ are below the keys ‘A’ to ‘I’, and the keys ‘S’ to ‘Z’ are below the keys ‘J’ to ‘Q’.

The input unit 11 also includes ‘space’ 16, ‘delete’ 17, ‘clear’ 18 and ‘on/of’ 19 keys. The ‘space’ and ‘delete’ keys together are designed to represent a yin/yang symbol. The ‘clear’ key 18 is used to clear the screen for entering a new word or phrase.

The shape of the device 10 is similar to that of a mobile phone. However, the device can be designed in other ergonomic shapes by keeping the arrangement of the input keys ‘1’ to ‘9’ and ‘A’ to ‘Z’ shown in FIG. 2.

A user can type in content such as words, phrases, dates, and a combination of letters and numbers by using the input keys, in conjunction with the ‘space’ key, and ‘delete’ key for corrections. In a preferred embodiment, the typed content is displayed on the left side of the screen 13. A first functional key 20 is included in the input unit 11 for calculating a single digit final total of the numbers assigned to the typed content. Initially, a first total of the individual numbers corresponding to individual letters is calculated. If the first total comprises multiple digits, a second total comprising the sum of the numbers in the first total is calculated. This process is repeated until the final total is reduced to a single digit.

Selecting the first functional key 20 can cause the final single digit total to be displayed on the screen 13. However, all the intermediate totals that eventually lead to the final total can also be displayed on the screen as they are entered. These totals are preferably displayed on the right side portion of the screen 13.

Additionally, two more functional keys, a second 21 and a third 22, are included in the input unit. The second functional key 21 is used for calculating the single digit final total of the assigned numbers of the vowels in a given text, and the third functional key 23 is used for calculating the single digit final total of the assigned numbers of the consonants in a given text.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 35 U.S.C. §112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A portable handheld device, comprising:
(a) an input unit comprising a plurality of selectable indicia, wherein at least some of the indicia correspond individually to a single number from 1 to 9 or a single letter from A to Z; so that all the letters from A to Z and all the numbers from 1 to 9 are represented on the unit by indicia;
(b) a display; and
(c) a processing unit for performing calculations.

2. The device of claim 1, further comprising indicia corresponding to a single space, and a single space, letter or number deletion.

3. The device of claim 2, wherein the number 1 corresopnds to the letters A, J and S; the number 2 corresponds to the letters B, K and T; the number 3 corresponds to the letters C, L and U; the number 4 corresponds to the letters D, M and V; the number 5 corresponds to the letters E, N and W; the number 6 corresponds to the letters F, O and X; the number 7 corresponds to the letters G, P and Y; the number 8 corresponds to the letters H, Q and Z; and the number 9 corresponds to the letters I and R.

4. The device of claim 3, wherein the processor automatically calculates the numerical value of any non-spaced text entered into the device; by adding the number assigned to each letter in the text; then, if the sum is more than one digit, by adding the individual digits in the sum, and continuing to add any single digits in subsequent sums, until a final single digit is reached.

5. The device of claim 4, wherein the device further comprises a function key for calculating the single digit total of multiple individual non-spaced texts entered into the device.

6. The device of claim 4, wherein the device further comprises a function key for calculating the single digit total of all vowels in single or multiple texts entered into the device.

7. The device of claim 4, wherein the device further comprises a function key for calculating the single digit total of all consonants in single or multiple texts entered into the device.

8. The device of claim 4, wherein the device further comprises a clear key for clearing entered text and preparing the device for a new calculation or set of calculations.

9. The device of claim 4, wherein the device further comprises a power on/off indicia which, when selected, turns the power of the device on and off.

10. The device of claim 1, wherein the processing unit is housed in the input unit and performs all of the calculations of the device.

11. The device of claim 1, wherein the display unit is attached to the input unit

12. The device of claim 11, wherein the display unit is attached to the input unit by a hinged connection, and the device can be opened and closed by rotating the display and input units about the hinged connection.

13. The device of claim 1, wherein the display unit comprises a screen for displaying entered data and calculated values.

14. The device of claim 13, wherein the device displays all calculations executed to reach a final single digit number.

15. The device of claim 2, wherein the single space, and single space, letter or number deletion indicia are designed to individually represent one of two halves of a yin/yang symbol.

16. The device of claim 15, wherein the indicia comprise keys on the device.

17. The device of claim 16, wherein the keys for A to I are individually disposed below individual keys 1 to 9, respectively; the keys for J to R are disposed below keys A to I; and the keys for S to Z are below keys J to Q, forming a row and column arrangement.

18. The device of claim 12, wherein the device further comprises a fastening device for holding the device closed when the input unit and screen are brought into alignment.

19. The device of claim 1, wherein the device comprises a memory means for retaining calculated data.

20. The device of claim 1, wherein the device comprises an elongated shape with convex and concaved dimensions.
